(19) United States
(12) Patent Application Publication
(10) Pub. No.: US 2021/0098992 A1
(43) Pub. Date: Apr. 1, 2021

(54) STATE MACHINE FOR WIND POWER PLANT

(71) Applicant: VESTAS WIND SYSTEMS A/S, Aarhus N (DK)

(72) Inventors: Rodrigo GARCIA, Gentofte (DK); Naveen Kumar BOGGARPU, Tilst (DK); Jorge Martinez GARCIA, San Juan de Aznalfarache (ES); Kouroush NAYEBI, Ikast (DK); Mu WEI, Solbjerg (DK); Dumitru-Mihai VALCAN, Langå (DK); Henrik MØLLER, Egå (DK); Jacob Barsøe KJÆRGAARD, Hinnerup (DK)

(21) Appl. No.: 16/603,709

(22) PCT Filed: Apr. 9, 2018
(86) PCT No.: PCT/DK2018/050070

§ 371 Date: Oct. 8, 2019

(30) Foreign Application Priority Data
Apr. 18, 2017 (DK) PA 2017 70268

(51) Int. Cl. H02J 3/38; F03D 7/02; F03D 7/04

(52) U.S. Cl. CPC H02J 3/381; F03D 7/0284; F05B 2270/1033; H02J 2300/28; F05B 2270/404; F03D 7/042

(57) ABSTRACT

The present invention relates to a state machine for controlling a wind power plant (WPP), comprising at least one wind turbine connected to an electrical grid, the state machine is adapted to, receive a plant power reference (P_total) according to at least one electrical value of the electrical grid, manage a plurality of control modes and output signals, in relation to the plurality of control modes, select within the control modes, according to controller inputs and contingency at that moment in time, transfer the corresponding control values to a power controller, and dispatch a power reference to each of the at least one wind turbines according to the selected control mode. The invention also relates to a control system arranged to control power output of a wind power plant (WPP), comprising at least one wind turbine connected to an electrical grid, and the control system having a state machine.

### FIELD OF THE INVENTION

The present invention relates to a state machine controlling a wind power plant, it also relates to a wind power plant and a wind power plant controller.

### BACKGROUND OF THE INVENTION

Modern power generation and distribution networks increasingly rely on renewable energy sources, such as wind turbines. Beyond merely generating and delivering electrical power, the wind turbines are responsible for contributing to grid stability through frequency regulation.

Wind turbines arranged in a wind power plant comprising a plurality of wind turbines, the wind power plant is controlled by a power plant controller, the plurality of wind turbines operates as one common power producing unit connected to a common point called a point of common coupling. Wind power plant is also known as a wind farm or a wind park.

Wind power plant has to provide grid support and thereby operate under different situations and be able to operate in all required situations.

The drawback of some wind power plants is that the transition between the different required situations is restricted.

It is therefore an object of the present invention to provide a system and method, which allows transition between and better operation in the required situations.

### SUMMARY

This Summary is provided to introduce a selection of concepts in a simplified form that are further described below in the Detailed Description.

A first aspect of the invention relates to a state machine for controlling a wind power plant (WPP), comprising at least one wind turbine connected to an electrical grid, the state machine is adapted to:
receive a plant power reference (P_total) according to at least one electrical value of the electrical grid,
manage a plurality of control modes and output signals, in relation to the plurality of control modes,
select within the control modes, according to controller inputs and contingency at that moment in time,
transfer the corresponding control values to a power controller, and
dispatch a power reference to each of the at least one wind turbines according to the selected control mode.

An advantage of the first aspect is that it is linked directly with the Power-frequency control loop of a power plant controller, controlling a wind power plant with a plurality of wind turbines. The Power-frequency control loop of a WPP controls the active power produced by the WPP according to the actual grid frequency, see FIG. 2. The State-Machine is situated inside the PPC. Its main function is to coordinate, prioritize and manage the control modes as well as the different output signal coming from them.

A second aspect of the invention relates to a control system arranged to control power output of a wind power plant (WPP), comprising at least one wind turbine connected to an electrical grid, the control system comprising:
one or more computer processors, arranged to control:
   a plant power reference (P_total) according to at least one electrical value of the electrical grid;
   a state-machine arranged to manage a plurality of control modes and output signals in relation to the plurality of control modes, wherein:
      the state-machine selects within the control modes, according to controller inputs and contingency at that moment in time and transfers the corresponding control values to a power controller, and
a dispatcher arranged for dispatching a power reference to each of the at least one wind turbines according to the selected control mode.

In an embodiment the wind power plant (WPP) comprises at least one wind turbine connected to an electrical grid and a control system.

In an embodiment of the first and second aspects the plurality of control modes are frequency control modes, active power control modes or low voltage ride through modes.

An advantage of the embodiment is that the machine selects within the most suitable frequency modes, according to the different inputs and contingency at that moment in time and transfers the corresponding values to the power controller block (Ploop) which calculates the required power production from the wind turbines based on power set point P_set and capabilities of the wind turbines. The requested power is then distributed to the individual wind turbines through the dispatcher.

In an embodiment of the first and second aspects the step of managing a plurality of control modes includes coordinate and prioritize the control modes.

In an embodiment of the first and second aspects the frequency modes includes at least: frequency control, over boost, inertia response, fast run back and low voltage ride through (LVRT) modes.

Wherein LVRT is the capability of an electric generator or wind turbine to stay connected in short periods of lower electric grid voltage (voltage dips). Similar Fault ride through (FRT) is a broader term covering various fault events, often described in connection terms set by the electrical transmission system operator (TSO or ISO). FRT may include over and under voltage and over and under frequency events.

A computer program product loadable into an internal memory of at least one processing device, the computer program product comprising software code portions for performing the steps of the method according to each of the claims 1 to 4.

Many of the attendant features will be more readily appreciated as the same become better understood by reference to the following detailed description considered in connection with the accompanying drawings. The preferred features may be combined as appropriate, as would be apparent to a skilled person, and may be combined with any of the aspects of the invention.

### BRIEF DESCRIPTION OF THE DRAWINGS

FIG. 1 shows a wind turbine,

FIG. 2 shows an example of an f-P curve,

FIG. 3 shows an example of a power plant controller with a state machine,

FIG. 4 shows an example of a state machine and it different states.

### DETAILED DESCRIPTION

The present invention will now be explained in further details.

The present embodiment relates to a state-machine for a power plant controller PPC, especially power-frequency control loop and includes different frequency control modes, including ancillary services provided by advanced frequency controls such as inertia response (IR) and over boost (OB) where active power is increased for a short period of time to help stabilizing the grid frequency. Finite-state machine is a mathematical computational tool, mainly design for control systems and sequential logic circuits, with a finite number of states and behaviors and system transitions from one state to another when certain conditions are satisfied.

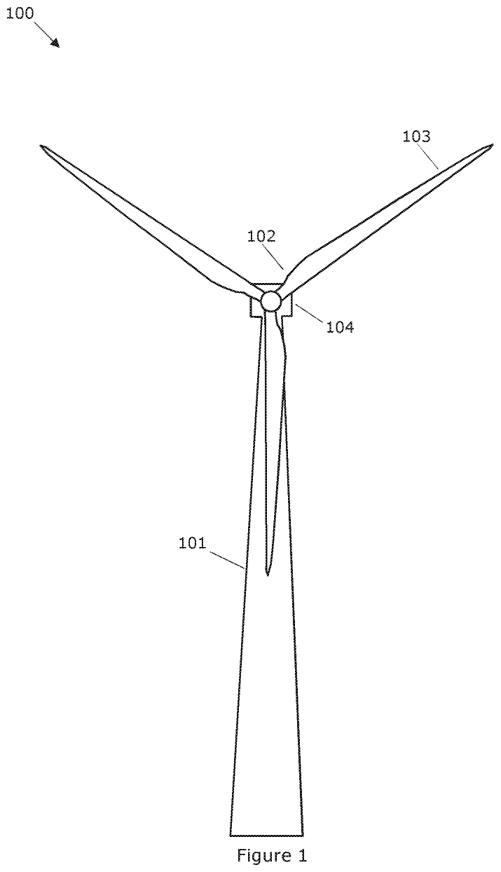

FIG. 1 shows a wind turbine 100 comprising a tower 101 and a rotor 102. The rotor comprises three rotor blades 103 however; the number may vary, such as two, four or even more blades. The rotor is connected to a nacelle 104 which is mounted on top of the tower 101 and being adapted to drive a generator situated inside the nacelle. The rotor 102 is rotatable by action of the wind. The wind induced rotational energy of the rotor blades 103 is transferred via a shaft to the generator. Thus, the wind turbine 100 is capable of converting kinetic energy of the wind into mechanical energy by means of the rotor blades and, subsequently, into electric power by means of the generator. The electrical layout of the wind turbine may in addition to the generator include a power converter. The power converter is connected in series between the generator and the electrical grid for converting the variable frequency generator AC power into a grid frequency AC power to be injected into the utility grid. The generator is via the power converter controllable to produce a power corresponding to a power request.

This invention is not limited to the above described wind turbine 100, other types of wind turbines, such as multi rotor designs with two or more rotors installed at a single tower may also be part of the invention.

In an embodiment there is a wind power plant with a plurality of wind turbines, where a power plant controller controls the wind power plant.

The Power Plant Controller (PPC) is a control system within a Wind Power Plant (WPP) which has the responsibility to control production of active power (P) and reactive power (Q), preferably at the Point of Interconnection (POI) with the utility grid (UG) from the WPP. The P and Q quantities are the means by which other system parameters can be influenced, such as the grid frequency (f) and voltage (V).

The controller structure has as inner loops the P and Q control, and outer loops the f and V control, the controller structure is not shown, but this is known to the skilled person.

Besides the core functionalities described above, the PPC is also responsible for other WPP functionalities which are required either by the Transmission System Operator (TSO) or the WPP owner.

The Active power control loop is responsible for controlling P at the point of interconnection. The active power control loop can be used to influence the grid frequency, by adding appropriate external control loops (primary frequency regulation, fast frequency response and inertia response). Power Oscillation Damping can be achieved as well by adding an appropriate external control loop.

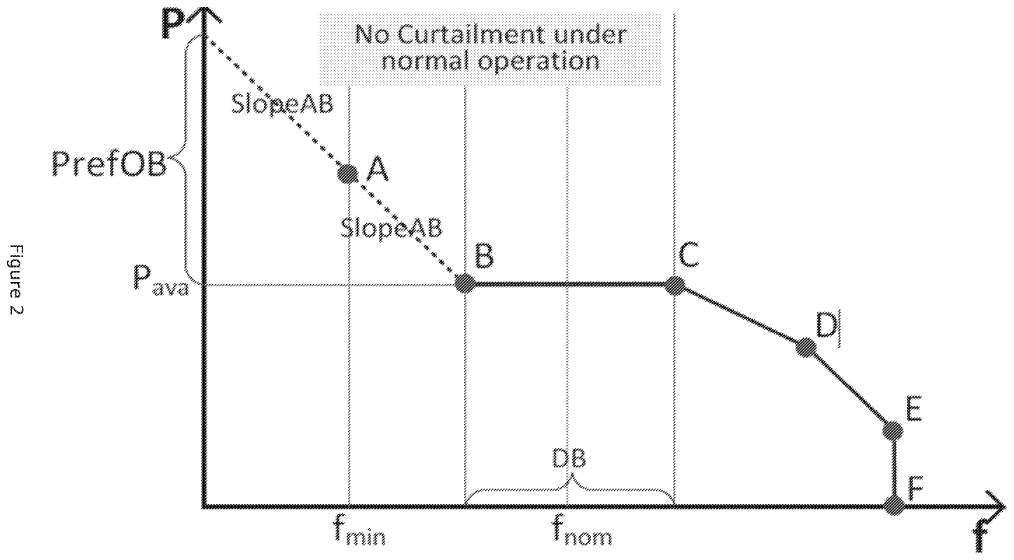

FIG. 2 shows the relationship between present electrical grid frequency and active power production. A nominal grid frequency fₙₒₘ is centered around a deadband DB, where the active power (segment B to C) follows the available active power Pₐᵥₐ, meaning the power which can be produced at the given wind speed available. Whenever the grid increases further than the positive deadband the active power from the WPP has to be reduced, see segment C to D and D to E. At a given grid frequency at point F the WPP has to stop delivering active power the electrical grid, this may trigger a fast run back FRB. Some transmission grids may require a rapid decrease in output power from Wind Power Plants (WPP); often such rapid decrease is called a “fast run-back”. This may be triggered by over-frequency excursions or other grid events.

The frequency controller according to prior art follows the solid part of the P-f lines in FIG. 2, i.e. the segment from B to F. This is to ensure that a further increase in the grid frequency is limited.

In the other end of the grid frequency scale of FIG. 2, i.e. below the negative frequency deadband, where there is a demand to supply more active power, than there is in fact available, this is possible by running the wind turbines in an over boost mode or inertia response, and thereby providing PrefOB, see segment B to A.

Basically, the P-f operation curve in FIG. 2 is followed all the time, i.e. where the requested active power production of the WPP follows the present electrical grid frequency.

The state-machine for PPC power-frequency control loop includes as mentioned before the different frequency control modes, including ancillary services provided by advanced frequency controls such as inertia response (IR) and/or over boost (OB), where the active power is increased for a short period of time to help stabilizing the grid frequency.

It also includes the coordination between the above mentioned control modes and fast run back FRB and Low voltage ride through LVRT blocks and different ram rate limiters RRLs is done within the state-machine.

Inertia response is a functionality where the wind power plant emulates the inertia response of a synchronous generator; this can be done by use of a power boost. Frequency control of a WPP based on inertia response may also be called emulated inertia or synthetic inertia.

During a power boost the power is increased from the normal production for a short period of time, i.e. power delivered to the electrical grid is increased for a short time above the current power set point. If the boost requires the wind turbine to deliver more power than can be drawn from the wind it is denoted over boost. The energy for delivering a boost or an over boost can be drawn from the kinetic energy stored in the rotor. As a wind turbine has a large rotor plane 102 with large blades 103, a large amount of kinetic energy is stored in the rotor 102 as rotor inertia, the rotational energy can be released by extracting more power, which then results in a reduction in the rotational speed of the rotor 102, and converting the mechanical energy into electrical power in the generator. This energy can then be used for a boot or an over boost. Afterwards the speed of the rotor should be increased again in order to return to optimum operation speed of the rotor.

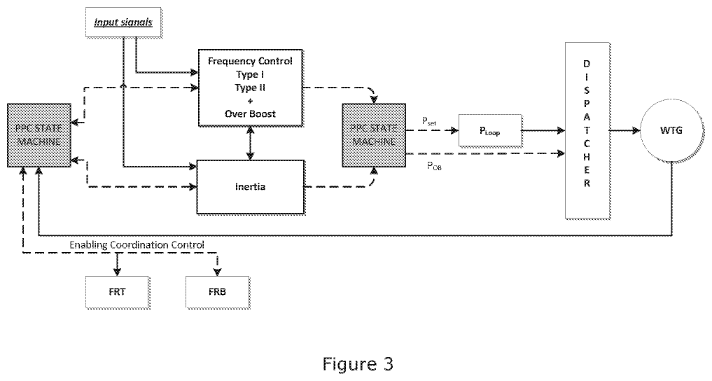

The concept selection for the State-machine is linked directly with the Power-frequency control loop of a power plant controller, controlling a wind power plant with a plurality of wind turbines. The flow chart model for the P-f State-Machine is shown in FIG. 3. The State-Machine is situated inside the PPC. Its main function is to coordinate, prioritize and manage the frequency control modes as well as the different output signal coming from them. The machine selects within the most suitable frequency modes, according to the different inputs and contingency at that moment in time and transfers the corresponding values to the power controller block (Ploop) and dispatcher. All the dashed lines in FIG. 3 shows actions controlled or enable by the state machine.

When an event in the grid frequency is detected, the state machine will consider and allow the possibility for each control feature to provide control. The state machine has the following features a selection mode: which selects the appropriate frequency control mode according to the specific disturbance, input signals and user settings. Prioritization mode: which prioritizes the use of power in the different frequency control modes. A wind turbine interface: which coordinate the different wind turbine output signals and to be transfer to the set points to the wind turbines, and a State Machine Coordination: which interacts and coordinates with the LVRT and FRB control blocks.

The finite-state machine has a finite number of states and behaviours and system transitions from one state to another when certain conditions are satisfy.

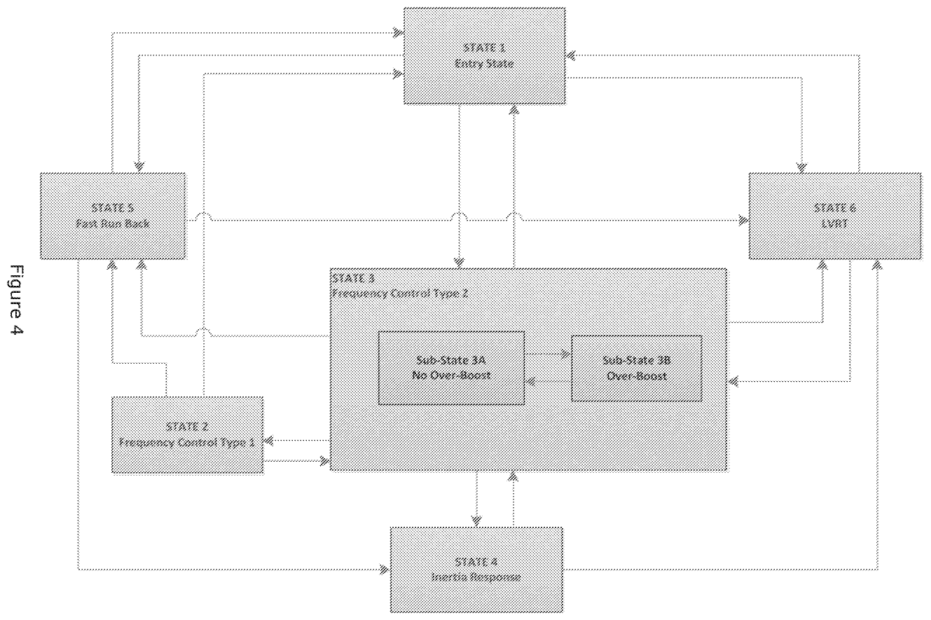

The machine can only be at one state at a time. The State-machine in one embodiment has in principle six main states, however it also encompasses two sub-states within the state 3. The different states and sub-states are shown in FIG. 4 and also listed as follow:
State 1: P-control (state status 1)
State 2: Frequency type 1 (state status 2)
State 3: Frequency type 2
   Sub-state 3A: No over-boost capability (state status 3)
   Sub-state 3B: Over-Boost capability (state status 4)
State 4: Inertia Response (state status 5)
State 5: Fast Run Back (state status 6)
State 6: Low Voltage Ride Through (state status 7)

In the following the different states will be explained in more details.

### State 1: Entry State P_Control Activated

When this state is enabled the user has the possibility to set/control the Pref for the WPP. The situation occurs for this state. There are no possible online transitions; the PPC must be reconfigured to get into a new control state, meaning that the state-machine will move directly to the chosen control state by the user. The transition from this state to others and vice versa is as described below.

Moving to: State 2 (Frequency Control Type 1), State 3 (Frequency Control Type 2), State 5 (Fast Run Back), State 6 (LVRT)

### State 2: Frequency Control Type 1

This state is related to the Frequency Type 1 control feature of the PPC. This frequency control mode has NO over boost feature at all, whereas Type 2 may have over boost (OB) capability. When the Frequency control is enabled, this is the sub-state of the PPC State-machine that will be activated. The possible transitions from this state are to the State 3 (3A, or 3B), State 5 or State 6, when it has been enabled by the user and the conditions to do this are available.

Similar to the transition from State 2 to State 3, when the transition from State 3 to State 2 is required, the Ploop will be manually disabled, so the user will have the possibility to reconfigure accordingly the Frequency control Type 2, and afterwards the Ploop will be manually enable again and this will allow the transition from State 3 to the State 2. There is no transition from State 2 to State 4, as this frequency control mode does not support the inertia response feature. The transition from this state to others and vice versa is as described below.

### Moving to: State 6 (LVRT or FRT), State 5 (Fast Run Back), State 1 (Pcontrol), State 3 (Frequency Control Type 2).

### State 3: Frequency Control Type 2

At this state the machine will consider the output values from the Frequency control mode Type 2 (with or without OB capability). The transition from the P-control to this state may happen when the user prefers to use the Frequency Control Type 2 feature of the PPC. There are five (5) different transitions from this state, which may occur under different circumstances, conditions and user settings. The transitions are:

1. From State 3 to State 2: If the user decides to change the frequency control mode to Type 1, this transition may occur. When this action occurs, the Ploop will be disable so the user will have the possibility to reconfigure accordingly the Frequency control Type 1, and afterwards the Ploop will be enable again and this will allow the transition from State 2 to the State 3.

2. From State 3 to State 4: If the IR feature is enabled and an inertial response is required, the state-machine will jump into this state.

3. From State 3 to State 5: The transition to this state may occur at any time if the FRB feature is configured by the user but also the condition for moving into this state is satisfied.

4. From State 3 to State 6: Similar to the previous one, when a LVRT event is detected, the state-machine will move forward into this state.

As part of the State 3, there are two sub-states to define more in detail the actions, outputs, condition and state of the PPC. The two (2) sub-states denominated as Sub-state 3A and 3B are described below. The transition overview from this state to others and vice versa is as described below.

Moving out/to: State 6 (LVRT or FRT), State 5 (Fast Run Back), State 1 (Pcontrol), State 2 (Frequency control Type 1).

Moving in/from: State 1 (P control), State 6 (LVRT/FRT), State 2 (Frequency control Type 1). FIG. 4-4 shows the overall situation for this state.

### Sub-state 3A: No Over-Boost

This sub-state is related to the Frequency Type 2 control features of the PPC with no Over-Boost. When the Frequency control is enabled, this is the sub-state of the PPC State-machine that will be activated. There is transition from this sub-state 3A to sub-state 3B, if the OB capability is enabled by the user and the conditions to do this are available.

The transition overview from this state to others and vice versa is as described below. The priority of them when moving out or to another state is written in the order from higher to lower priority.

### Moving Out/to: State 3B (Over-Boost), State 4 (Inertia Response)

Moving in/from: State 3B (Over-Boost)

### Sub-State 3B: Over-Boost

This sub-state is activated when the OB capability is needed according to circumstance, conditions and user settings. Refer to FIG. 4-4 for more details and parameters for these states. The transition overview from this state to others and vice versa is as described below.

### Moving Out/to: State 3A (No Over-Boost)

Moving in/from: State 3B (No Over-Boost)

### State 4: Inertia Response

This feature as well as the OB capability previously mentioned in the “Sub-state 3B”, corresponds to the AS provided by the PPC. The transition into this state may possibly come from the State 3A and 3B, and it can shift to State 1, 4, 5 and 6 depending on the circumstances, conditions and user settings. The probable transitions are:

1. From State 4 to State 2: The machine will move back directly into the State 3 (3A or 3B) after the IR feature has finished.

2. From State 4 to State 5: When the FRB is configured and enabled in the PPC, that may be a possible switch from State 3 to State 4, if the conditions are satisfied to do this transition.

3. From State 4 to State 6: Again if the LVRT feature is enabled and set up by the user, this change may occur when appropriate.

The transition overview from this state to others and vice versa is as described below.

Moving out/to: State 6 (LVRT/FRT), State 3 (Frequency Control Type 2)
Moving in/from: State 3A (No Over-Boost), State 5 (FRB)

### State 5: Fast Run Back

This state interacts and responds to certain event and/or conditions in the system, therefore, the possibility for moving from any other state at any at time (according to user settings and conditions) into this State 5: Fast Run Back is always possible. The probable transitions are:

1. From State 1, 2, 3, to State 5: This transition may occur at any time when an event or conditions satisfying the requirements for the FRB frequency control loop is fulfilled.

The transition overview from this state to others and vice versa is as described below.

### Moving Out/to: State 6 (LVRT/FRT), State 1 (Entry State), State 4 (Inertia Response)

Moving in/from: State 1 (P Control), State 3 (Frequency Control Type 2), State 2 (Frequency Control Type 1)

### State 6: Low Voltage Ride Through

Similar to the State 5, this state also reacts when a LVRT event is detected; the transition from all the other states into this one is possible. This state has the highest priority.

For moving out from this state, it is only possible when the fault has passed, and a LVRT flag is zero (0), and then depending of the user settings it may switch to State 1, State 2, State 3 and State 5.

FIG. 4 gives an illustration and a general overview of the state and sub-states of the PCC State-machine. The transition overview from this state to others and vice versa is as described below.

### Moving Out/to: State 1 (Pcontrol), State 2 (Frequency Control Type 1), State 3 (Frequency Control Type 2), State 5 (Fast Run Back)

Moving in/from: State 1 (Pcontrol), State 2 (Frequency Control Type 1), State 3 (Frequency Control Type 2), State 5 (FRB), State 4 (Inertia Response)

### Overview, Events and Transitions

Apart from the case when the user would like to get as a constant value the output reference power to the WPP (State 1) and under normal conditions in the grid, meaning no events such as FRB or LVRT, the state-machine will move into State 2 (Frequency control Type 1) or State 3 (Frequency control Type 2). These states correspond directly to the enabling of the Frequency Mode in the PPC. The State-machine does not allow online transition from the different frequency mode states, meaning that in order to move from State 2 (Frequency Type 1) to State 3 (Frequency Type 2, Over boost) the PPC must be restarted/reinitialised in order to move to the selected new state, the same situation is from moving on the other direction. When a transition like this occurs, the Ploop in the PPC is disable and after the proper configuration of the selected State (control mode) the Ploop is enable again so the transition from one state to another can be executed.

In an embodiment the State-machine also operates with a number of states when the PPC is set to control the active power from the wind turbines, i.e. P_ctrl mode. The same applies to an embodiment with a state machine with the PPC set to control the wind turbines in an Inertia response mode, providing short term increased active power.

In an embodiment the State-machine does in fact allow online transition from the different states without restarting the PPC.

When an event in frequency is detected, the state machine will consider and allow the possibility for each control feature to provide control.

As an example, in the case of a frequency event that requires the inertia response (IR), the following transition states may occur:

a. Under deadband limits and conditions, and when the user has enable the Frequency control mode, the state-machine will be at State 3: Frequency Control Type 2

b. A fast frequency change is registered, the IR control block sends a request to the state-machine, and it is granted, then the state-machine will allow the transition to the State 4: IR.

c. When the IR had occurred, the state-machine will get a signal from the IR control block, and the state transition will move from State 4 to State 3.

For all the previous possible transitions, the state-machine will do a switch into the corresponding state, and it will ensure and take care of the different parameters, conditions and output values from those states. The state-machine is designed in such a way that it will prioritize the frequency loop controls modes.

One aspect relates to a state machine for controlling a wind power plant (WPP), comprising at least one wind turbine connected to an electrical grid, the state machine arranged to: receive a plant power reference (P_total) according to at least one electrical value of the electrical grid, manage a plurality of frequency control modes and output signals in relation to the plurality of frequency control modes, select within the frequency modes, according to controller inputs and contingency at that moment in time and transfers the corresponding values to a power controller, and dispatch a power reference to each of the at least one wind turbines according to the selected frequency mode.

In an embodiment, the step of managing a plurality of frequency control modes includes coordinate and prioritize the frequency control modes.

In an embodiment, the frequency modes includes at least: frequency control, over boost, inertia response, fast run back and low voltage ride through modes.

Another aspect relates to a state machine for controlling a wind power plant (WPP), comprising at least one wind turbine connected to an electrical grid, the state machine is arranged to: receive a plant power reference (P_total) according to at least one electrical value of the electrical grid, manage a plurality of control modes and output signals in relation to the plurality of control modes, select within the control modes, according to controller inputs and contingency at that moment in time and transfers the corresponding values to a power controller, and dispatch a power reference to each of the at least one wind turbines according to the selected frequency mode.

A second aspect relates to a control system arranged to control power output of a wind power plant (WPP), comprising at least one wind turbine connected to an electrical grid, the control system comprising, one or more computer processors, arranged to control:

a plant power reference (P_total) according to at least one electrical value of the electrical grid;
a state-machine arranged to manage a plurality of control modes and output signals in relation to the plurality of frequency control modes, wherein:
the state-machine selects within the frequency control modes, according to controller inputs and contingency at that moment in time and transfers the corresponding values to a power controller, and a dispatcher arranged for dispatching a power reference to each of the at least one wind turbines according to the selected frequency mode.

It is clear that the state machine can work in a wind power plant (WPP) comprising at least one wind turbine connected to an electrical grid, the embodiments explained above are examples, and the state machine is not limited to the transitions disclosed, but more to explain the principle.

An aspect also relates to a computer program product loadable into an internal memory of at least one processing device, the computer program product comprising software code portions for performing the steps of the method and the state machine.

Embodiments of invention can be implemented by means of electronic hardware, software, firmware or any combination of these. Software implemented embodiments or features thereof may be arranged to run on one or more data processors and/or digital signal processors. Software is understood as a computer program or computer program product which may be stored/distributed on a suitable computer-readable medium, such as an optical storage medium or a solid-state medium supplied together with or as part of other hardware, but may also be distributed in other forms, such as via the Internet or other wired or wireless telecommunication systems. Accordingly, the computer-readable medium may be a non-transitory medium. Accordingly, the computer program comprises software code portions for performing the steps according to embodiments of the invention when the computer program product is run/executed by a computer or by a distributed computer system.

Although the present invention has been described in connection with the specified embodiments, it should not be construed as being in any way limited to the presented examples. The scope of the present invention is to be interpreted in the light of the accompanying claim set. In the context of the claims, the terms “comprising” or “comprises” do not exclude other possible elements or steps. Also, the mentioning of references such as “a” or “an” etc. should not be construed as excluding a plurality. The use of reference signs in the claims with respect to elements indicated in the figures shall also not be construed as limiting the scope of the invention. Furthermore, individual features mentioned in different claims, may possibly be advantageously combined, and the mentioning of these features in different claims does not exclude that a combination of features is not possible and advantageous.

1. A method of controlling a wind power plant (WPP), comprising at least one wind turbine connected to an electrical grid, the method, comprising:
receiving a plant power reference (P_total) according to at least one electrical value of the electrical grid,
managing a plurality of control modes and output signals, in relation to the plurality of control modes,
selecting a control mode from the plurality of control modes, according to controller inputs and contingency at that moment in time,
transferring the corresponding control values to a power controller, and
dispatching a power reference to each of the at least one wind turbines according to the selected control mode.

2. The method according to claim 1, wherein the plurality of control modes includes: frequency control modes, active power control modes or low voltage ride through modes.

3. The method according to claim 1, wherein the step of manage a plurality of control modes includes coordinate and prioritize the control modes.

4. The method according to claim 1, wherein the frequency modes includes at least: frequency control, over boost, inertia response, fast run back and low voltage ride through modes.

5. A control system arranged to control power output of a wind power plant (WPP), comprising at least one wind turbine connected to an electrical grid, the control system comprising:
one or more computer processors, arranged to control:
a plant power reference (P_total) according to at least one electrical value of the electrical grid;
a state-machine arranged to manage a plurality of control modes and output signals in relation to the plurality of control modes, wherein:
the state-machine selects a control mode from the plurality of control modes, according to controller inputs and contingency at that moment in time and transfers the corresponding control values to a power controller, and
a dispatcher arranged for dispatching a power reference to each of the at least one wind turbines according to the selected control mode.

6. A wind power plant (WPP) comprising at least one wind turbine connected to an electrical grid and a control system according to claim 5.

7. A computer program product loadable into an internal memory of at least one processing device, the computer program product comprising software code portions for performing the method according to claim 1.

8. The computer program product of claim 7, wherein the plurality of control modes includes: frequency control modes, active power control modes or low voltage ride through modes.

9. The system according to claim 7, wherein the step of manage a plurality of control modes includes coordinate and prioritize the control modes.

10. The system according to claim 7, wherein the frequency modes includes at least: frequency control, over boost, inertia response, fast run back and low voltage ride through modes.

11. A wind turbine system, comprising:
at least one wind turbine connected to an electrical grid; and
a control system connected to the at least one wind turbine, wherein the control system performs an operation, comprising:
receiving a plant power reference (P_total) according to at least one electrical value of the electrical grid;
managing a plurality of control modes and output signals, in relation to the plurality of control modes;
selecting a control mode from the plurality of control modes, according to controller inputs and contingency at that moment in time;
transferring the corresponding control values to a power controller, and
dispatching a power reference to each of the at least one wind turbines according to the selected control mode.

12. The system according to claim 11, wherein the plurality of control modes includes: frequency control modes, active power control modes or low voltage ride through modes.

13. The system according to claim 11, wherein the step of manage a plurality of control modes includes coordinate and prioritize the control modes.

14. The system according to claim 11, wherein the frequency modes includes at least: frequency control, over boost, inertia response, fast run back and low voltage ride through modes.
